(19) United States
(12) Patent Application Publication
(10) Pub. No.: US 2012/0062913 A1
(43) Pub. Date: Mar. 15, 2012

(54) INFORMATION PROCESSING APPARATUS, INFORMATION PROCESSING METHOD AND STORAGE MEDIUM

(75) Inventor: Takashi Yabe, Yokohama-shi (JP)

(73) Assignee: CANON KABUSHIKI KAISHA, Tokyo (JP)

(21) Appl. No.: 13/227,334

(22) Filed: Sep. 7, 2011

(30) Foreign Application Priority Data
Sep. 13, 2010 (JP) 2010-204250

(51) Int. Cl. G06F 15/00

(52) U.S. Cl. 358/1.9

(57) ABSTRACT

A printer according to the present invention includes a central processing unit (CPU) configured to be able to process variable data printing (VDP) data including reusable data which is repeatedly utilized in a plurality of pages, and variable data which is not repeatedly utilized, to generate a plurality of intermediate language data from the reusable data, according to a plurality of settings for color processing, and to select intermediate language data to be used when generating a bitmap image, from the plurality of intermediate language data generated by a generation unit, and a RIP unit configured to generate a bitmap image by performing RIP-processing on the selected intermediate language data.

### BACKGROUND OF THE INVENTION

1. Field of the Invention

The present invention relates to an image processing apparatus for performing variable data printing (VDP) by changing, according to variable data (i.e., data that cannot be referred to a plurality of times), color matching of images represented by reusable data (i.e., common data that can be referred to a plurality of times), a control method for such an image processing apparatus, and a storage medium that stores a program for causing an image processing apparatus to execute such a control method.

2. Description of the Related Art

With recent years' expansion of a market of one-to-one marketing, direct mails have become widespread, which provides information that meets individual customers' needs. Special VDP page description languages (PDLs) typified by a personalized print markup language (PPML (registered trademark)) are employed in direct-mail VDP jobs. Variable data includes the following three types of data, namely, reusable data iteratively used in each page, a large number of variable data including customer information, and PDL data defining document information.

However, color processing is performed in interpreters for PDLs, such as PostScript (registered trademark) (PS), a portable document format (PDF), “Joint Photographic Experts Group (JPEG) direct”, and a “tag image file format (TIFF) direct”, used by PPML. Accordingly, settings for color processing should be determined before the color processing is started in the interpreter.

Typical settings for a color processing system CMS (color matching system) are an “image quality priority setting” and a “counter priority setting”. The “image quality priority setting” is made to reproduce each black or gray part of an image by mixing ink of four types, i.e., cyan (c), magenta (M), yellow (Y), and black (BK). Thus, according to the “image quality priority setting”, a smooth gradation in gray levels of the black or gray part can be achieved to give importance to the image quality. The “counter priority setting” is made to reproduce each black or gray part of an image with only ink of a single type, i.e., BK. According to the “counter priority setting”, a printing-machine is operated in anachromatic-color mode by reproducing the black part with only BK ink. Thus, a chromatic-color/achromatic-color counter counts even a full-color image as an achromatic one. Accordingly, processing cost can be suppressed.

The “image quality priority setting” or the counter priority setting” is preliminarily determined as color-processing default setting. Among VDP languages, PPML includes PS, PDF, “JPEG direct”, and “TIFF direct”. Further, the setting for the color processing has been compliant with that for PS, PDF, “JPEG direct”, or “TIFF direct”. In addition, the reusable data which is characteristic data in the VDP and repeatedly used, is once generated in the color processing performed by the interpreter, and the generated data is used repeatedly a number of times. Accordingly, performance is improved.

Japanese Patent Application Laid-Open No. 2008-152624 discusses technology for analyzing data used in VDP jobs, and switching between offset printing and digital printing in a work-flow. More specifically, a group of data, which is common to each page, is output by an offset printer at high speed. However, when a group of data having variable parts differing in each page is printed, the different pages are output by a digital printer. Consequently, a turnaround time of each variable job can be reduced. In addition, the cost can be lowered.

Under the above background, as digital printers become faster, cases of outputting all data of VDP jobs by a digital printer are increasing. Thus, there are demands for a digital printer which prints data with the highest possible image quality, while output of the digital printer is lower in image quality than the offset printer. However, because the offset printer is higher in cost than the digital printer, there are increasing demands for cost reduction as much as possible.

In addition, in the VDP, reusable data and variable data are variously combined with one another. The reusable data often represents images such as a commodity image and a background image. Although it is desired to output an image with a smooth tone and the highest possible image quality by giving importance to the image quality, it is required in the case of a monochromatic black-and-white image to suppress the cost, instead of outputting the image with colors by giving importance to the image quality. However, in the conventional systems, the image quality priority setting is incompatible with the counter priority setting. Thus, one of the image quality priority setting and the counter priority setting should preliminarily be determined as the setting for the color processing system.

If the image quality priority setting is made as the default setting for CMS devices, while the black and gray gradation becomes smooth, color printing is performed many times, so that the cost increases. On the other hand, if the counter priority setting is made as the default setting for the CMS devices, the black or gray part is reproduced with toner of a single color BK. Thus, this setting is advantageous in the cost. However, this setting has a problem that regarding the image quality, the smoothness of the tonal change is less than the tonal change in the case of using the image quality priority setting.

### SUMMARY OF THE INVENTION

The present invention is directed to an image processing apparatus capable of performing, when data in VDP jobs are printed, image processing with good balance between the image quality and the cost.

According to an aspect of the present invention, an image processing apparatus for processing VDP data including reusable data which is repeatedly utilized in a plurality of pages, and variable data which is not repeatedly utilized. The image processing apparatus includes a generation unit configured to generate a plurality of intermediate language data from the reusable data, according to a plurality of settings for color processing, a selection unit configured to select intermediate language data to be used when generating a bitmap image, from the plurality of intermediate language data generated by the generation unit, and a raster image processor (RIP) unit configured to generate a bitmap image by performing RIP-processing on the intermediate language data selected by the selection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a VDP system according to a first exemplary embodiment of the present invention.

FIG. 2 is a flowchart illustrating a flow of processing in the first exemplary embodiment of the present invention.

FIG. 3 is a flowchart illustrating a process of generating a reusable display list (DL) according to the first exemplary embodiment of the present invention.

FIG. 4 is a flowchart illustrating a process of generating a variable DL according to the first exemplary embodiment of the present invention.

FIG. 5 is a flowchart illustrating a flow of the process of generating a reusable DL according to a seventh exemplary embodiment of the present invention.

FIG. 6 is a diagram illustrating an example of a screen displayed in a user interface (UI) according to a second exemplary embodiment of the present invention.

FIG. 7 is a diagram illustrating an example of a screen displayed in a UI according to a third exemplary embodiment of the present invention.

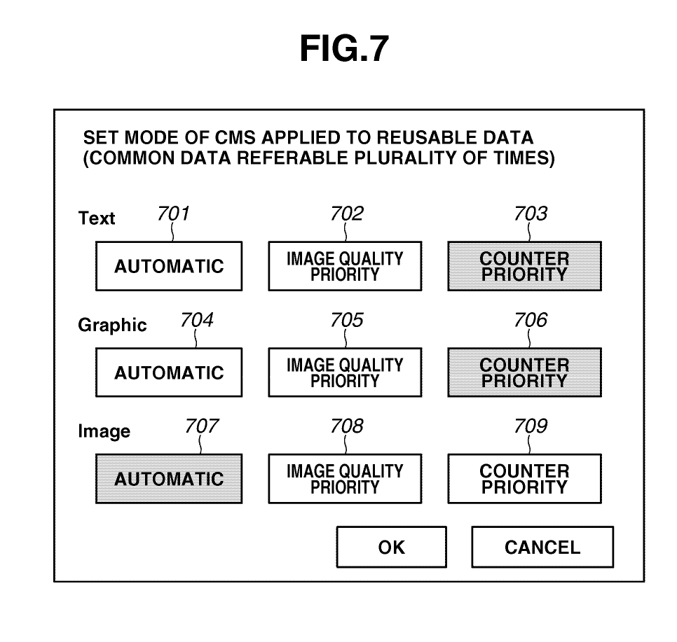

FIG. 8 is a diagram illustrating an example of a screen displayed in a UI according to a fourth exemplary embodiment of the present invention.

FIG. 9 is a diagram illustrating an example of a screen displayed in a UI according to a fifth exemplary embodiment of the present invention.

FIG. 10 is a diagram illustrating an example of a screen displayed in a UI according to a sixth exemplary embodiment of the present invention.

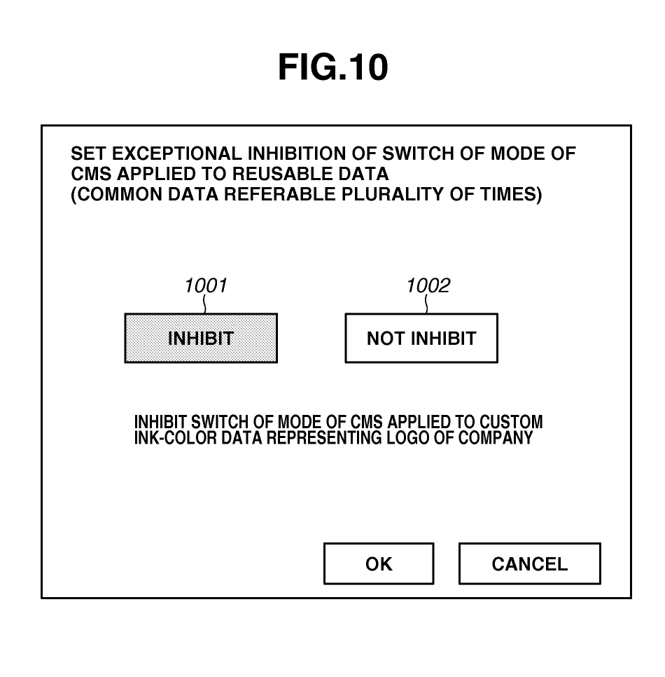

FIG. 11 is a diagram illustrating an example of print data according to an exemplary embodiment of the present invention.

FIG. 12 is a diagram illustrating an example of print data according to an exemplary embodiment of the present invention.

FIG. 13 is a diagram illustrating an example of print data according to an exemplary embodiment of the present invention.

FIG. 14 is a diagram illustrating an example of print data according to an exemplary embodiment of the present invention.

FIG. 15 is a diagram illustrating an example of print data according to an exemplary embodiment of the present invention.

FIG. 16 is a diagram illustrating an example of data generated according to an image quality priority setting and a counter priority setting according to the present invention.

### DESCRIPTION OF THE EMBODIMENTS

Various exemplary embodiments, features, and aspects of the invention will be described in detail below with reference to the drawings.

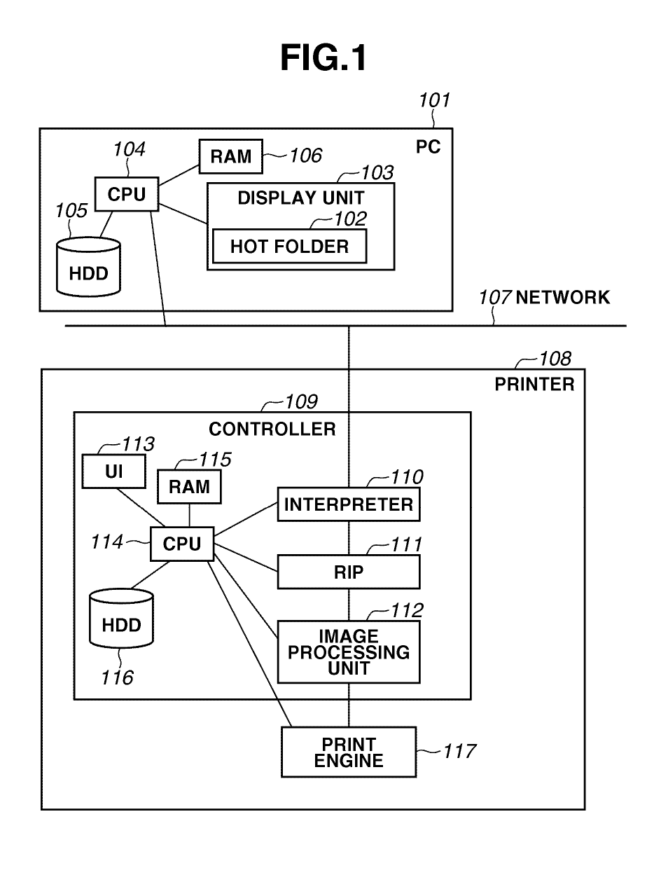

Hereinafter, a first exemplary embodiment according to the present invention is described with reference to FIG. 1. FIG. 1 is a block diagram illustrating a configuration of a VDP system to which the present exemplary embodiment is applied. The VDP system is configured to include a personal computer (PC) 101 serving as an information processing apparatus to which the present invention is applied, and a printer 108 serving as an image processing apparatus to which the present invention is applied. The PC 101 and the printer 108 are connected to each other via a network 107 to communicate with each other.

The PC 101 includes a hot folder 102, a display unit 103, a central processing unit (CPU) 104, a hard disk drive (HDD) 105, and a random access memory (RAM) 106. The hot folder 102 transmits direct print data such as PPML data to the printer 108 via the network 107. The display unit 103 displays, via the CPU 104, a state of the PC 101 including the hot folder 102 and the HDD 105. The CPU 104 is a central processing unit used for various processing in the PC 101. The HDD 105 is used to store various data such as data concerning the PC 101, and direct print data such as PPML data. Such various data is read from the HDD 105 and used for the processing. The RAM 106 is a data storage means used for various arithmetic processing performed in the CPU 104 and for various processing performed in the PC 101.

A printer 108 includes a controller 109 and a print engine 117. A controller 109 includes an interpreter 110, a RIP 111, an image processing unit 112, a UI 113, a CPU 114, a RAM 115, and a HDD 116. The interpreter 110 interprets and translates PDL print data such as PPML data sent from the PC 101 via the network 107. The RIP 111 converts the interpreted print data into bitmap print data corresponding to each page. The image processing unit 112 converts the bitmap print data into the most appropriate print data for the print engine. The UI 113 displays various states of the printer 108 and inputs various settings into the printer 108. The CPU 114 is a central processing unit used for various processing to be performed by each of the printer 108 and the print engine 117. The RAM 115 is a data storage means used for various processing performed in the printer 108 and the print engine 117. The HDD 116 stores various data such as data relating to the printer 108 and the printer engine 117, and print data. Such various data is read from the HDD 116 and used for the processing. The print engine 117 actually prints print data generated by the controller 109.

Next, a simple operation of the VDP system illustrated in FIG. 1 is described hereinafter. First, the PC 101 generates VDP data, using an application program (not shown) for generating PPML data. The generated data is converted into a Zip (registered trademark) file that is saved in the HDD 105. The saved file is stored in the hot folder 102 displayed on the display unit of the PC 101. To print the VDP data corresponding to the stored file, the VDP data can be input to the printer 108 via the network 107. The input VDP data is interpreted and translated by the interpreter 110 in the controller 109. The data interpreted and translated therein is converted by the RIP 111 into bitmap data corresponding to each page. Such bitmap data is converted and corrected by the image processing unit 112 into the most appropriate print data for the print engine 117. The print data for the print engine is printed and output by the print engine 117.

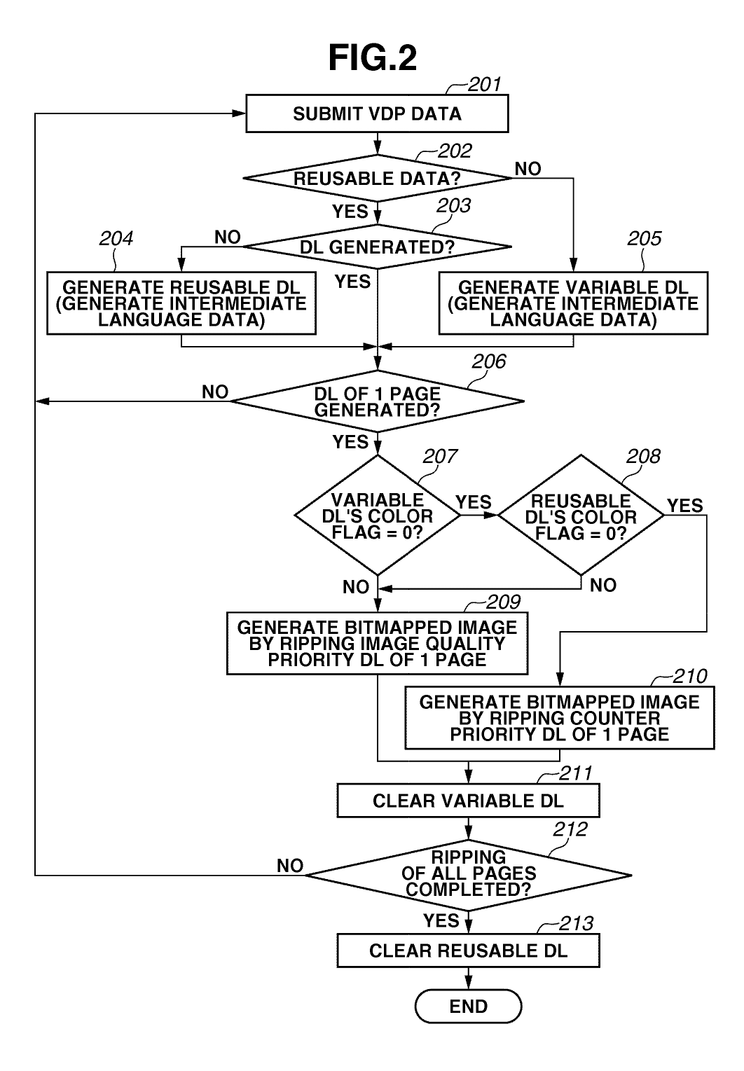

FIG. 2 is a flowchart illustrating a flow of a process of generating a bitmap image by the interpreter 110 and the RIP 111 under the control of the CPU 114 after VDP data is submitted thereto (that is, a print job is submitted).

First, when VDP data is submitted from the PC 101, in step 201, the CPU 114 receives the input VDP data. The VDP data includes reusable data (i.e., common data that can be referred to a plurality of times) and variable data (i.e., data that cannot be referred to a plurality of times). Then, in steps 202 to 206, display lists (DL) of data to be printed (i.e., target data) are sequentially generated. The DL is an intermediate language data used in the process of interpreting PDL included in the VDP data and generating a bitmap image.

In step 202, the CPU 114 determines whether the target data is reusable data to be repeatedly used. If the CPU 114 determines that the target data is reusable data (Yes in step 202), the CPU 114 proceeds to step 203. If the CPU 114 determines that the target data is not reusable data (in other words, the target data is variable data (No in step 202)), the CPU 114 proceeds to step 205.

In step 203, the CPU 114 determines whether a DL of the target data has already been generated. Because reusable data is repeatedly used, the DL of the data previously submitted has already been generated. Thus, it is unnecessary to generate the DL again. Accordingly, in step 203, it is determined whether the DL has already been generated. If it is determined that the DL of the target data has already been generated (Yes in step 203), the CPU 114 proceeds to step 206. If it is determined that the DL of the target data has not yet been generated (No in step 203), the CPU 114 proceeds to step 204.

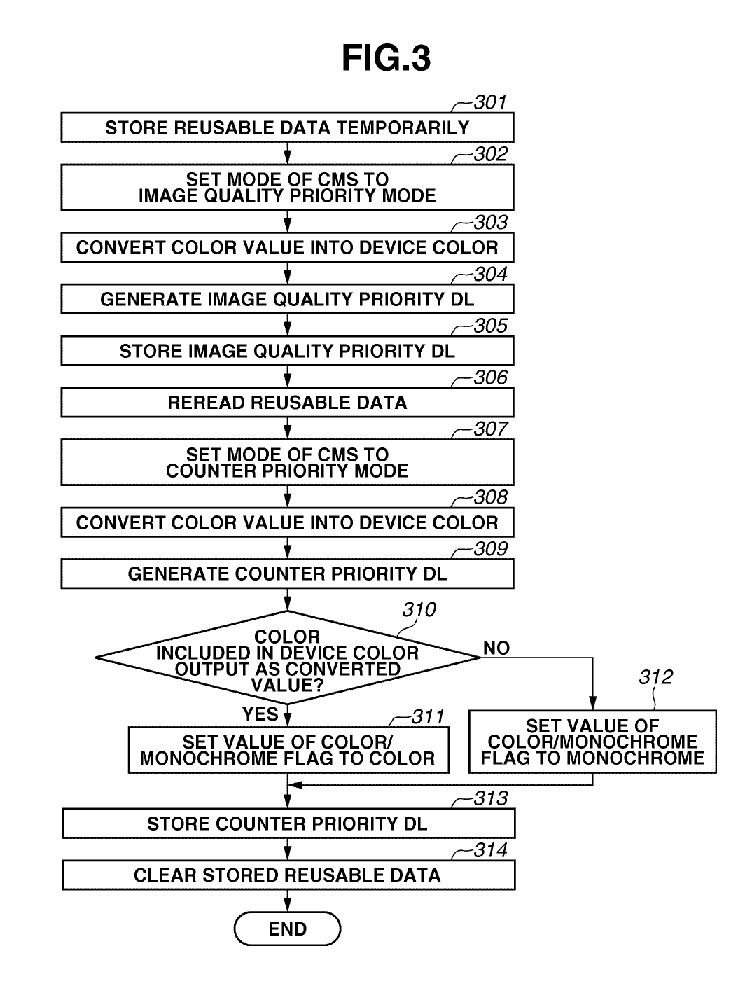

In step 204, the CPU 114 controls the interpreter 110 to generate a reusable DL serving as intermediate language data corresponding to the reusable data. A process of generating the reusable DL in step 204 is described below in detail with reference to FIG. 3. In step 204, two types of DLs, i.e., an image quality priority DL and a counter priority DL are generated as the reusable DL. The image quality priority DL is generated when the setting for the color processing system CMS is the image quality priority setting. The counter priority DL is generated when the setting for the color processing system CMS is the counter priority setting. A bitmap image generated from the image quality priority DL is higher in image quality than that generated from the counter priority DL, and can achieve the smooth gradation. On the other hand, the bitmap image generated from the counter priority DL can be output only in a single color BK. Thus, the counter priority DL can suppress the cost, as compared with the image quality priority DL.

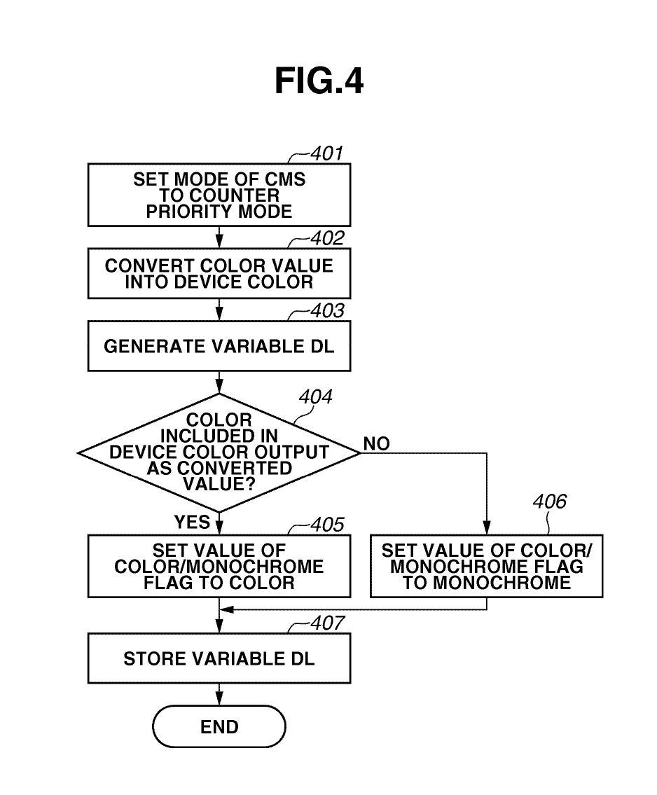

In step 205, the CPU 114 controls the interpreter 110 to generate a variable DL serving as intermediate language data corresponding to the variable data. A process of generating the variable DL in step 205 is described below in detail with reference to FIG. 4. In step 206, the CPU 114 determines whether a DL of the target data corresponding to a single page is generated. If the CPU 114 determines that the DL of the target data corresponding to a single page is generated (Yes in step 206), the CPU 114 proceeds to step 207. On the other hand, if the CPU 114 determines that the DL of the target data corresponding to a single page is not generated (No in step 206), the CPU 114 returns to step 201 in which the CPU 114 waits for submission of the next VDP data.

In step 207, the CPU 114 determines whether a color flag of the variable DL indicates 0. If the CPU 114 determines that the color flag of the variable DL indicates 0 (Yes in step 207), the CPU 114 proceeds to step 208. If the CPU 114 determines that the color flag of the variable DL doesn't indicate 0 (more specifically, the color flag indicates 1 or more (No in step 207), the CPU 114 proceeds to step 209. In step 208, the CPU 114 determines whether a color flag of the reusable DL indicates 0. If the CPU 114 determines that the color flag of the reusable DL indicates 0 (Yes in step 208), the CPU 114 proceeds to step 210. If the CPU 114 determines that the color flag of the reusable DL doesn't indicate 0 (more specifically, the color flag indicates 1 or more (No in step 208)), the CPU 114 proceeds to step 209. The color flag of each of the DLs is described below in the following detailed description of DL generation processing in steps 204 and 205.

In step 209, the CPU 114 controls the RIP 111 to generate (perform RIP-processing), from the DL of 1 page, a bitmap image corresponding to the 1-page. At that time, the CPU 114 controls the RIP 111 to use the image quality priority DL as a reusable DL to be used for RIP-processing of the bitmap image. In step 210, the CPU 114 controls the RIP 111 to generate (perform RIP-processing), from a DL of 1 page, a bitmap image corresponding to the 1-page. At that time, the CPU 114 controls the RIP 111 to use a counter priority DL as the reusable DL to be used for RIP-processing of the bitmap image.

In step 211, the CPU 114 clears the variable DL. This is because the variable DL is not repeatedly used in other pages within the job. In step 212, the CPU 114 determines whether the RIP-processing of all pages included in the job is completed. If the CPU 114 determines that the RIP-processing of all pages is completed (Yes in step 212), the CPU 114 proceeds to step 213. If the CPU 114 determines that the RIP-processing of all pages is not completed (No in step 212), the CPU 114 proceeds to step 213.

In step 213, the CPU 114 clears the reusable DLs. This is because the RIP-processing of all pages has already been completed, and the reusable DLs are unnecessary.

After the reusable DLs (i.e., the image quality priority DL and the counter priority DL) are cleared in step 213, the CPU 114 finishes the process illustrated in this flowchart.

FIG. 3 is a flowchart illustrating in detail the process of generating the reusable DLs in step 204 in the flowchart illustrated in FIG. 2. In step 301, the CPU 114 temporarily stores reusable data serving as the target data to generate two types of DLs, i.e., an image quality priority DL and a counter priority DL.

In step 302, the CPU 114 makes the image quality priority setting as the setting for the color processing system CMS. In step 303, the CPU 114 converts a color value of the target data into a device color corresponding to the image quality priority setting. In step 304, the CPU 114 generates an image quality priority DL from the target data whose color value is converted into the device color corresponding to the image quality priority setting. In step 305, the CPU 114 stores the generated image quality priority DL.

In step 306, the CPU 114 rereads and acquires the target data (reusable data) temporarily stored in step 301. Then, in step 307, the CPU 114 makes the counter priority setting as the setting for the color processing system including the SCM. In step 308, the CPU 114 converts the color value of the target data into a device color according to the counter priority setting. In step 309, the CPU 114 generates a counter priority DL from the target data whose color value is converted into the device color according to the counter priority setting.

In step 310, in the case of the counter priority setting, a black part is printed in a single color BK. In other words, the black part is monochromatic. Thus, the CPU 114 determines whether the device color into which the color value of the data is converted in step 308 includes a chromatic-color. If the CPU 114 determines that the device color includes a chromatic-color (Yes in step 310), the CPU 114 proceeds to step 311. If the CPU 114 determines that the device color doesn't include a chromatic-color (No in step 310), the CPU 114 proceeds to step 312.

In step 311, the CPU 114 increments and sets the value of a chromatic-color/achromatic-color flag of the reusable DL to a chromatic-color. In step 312, the CPU 114 doesn't increment the value of the chromatic-color/achromatic-color flag of the reusable DL. Thus, the value of a chromatic-color/achromatic-color flag is set to an achromatic-color. In step 313, the generated counter priority DL is saved. In step 314, the saved target data is cleared. Then, the process is ended.

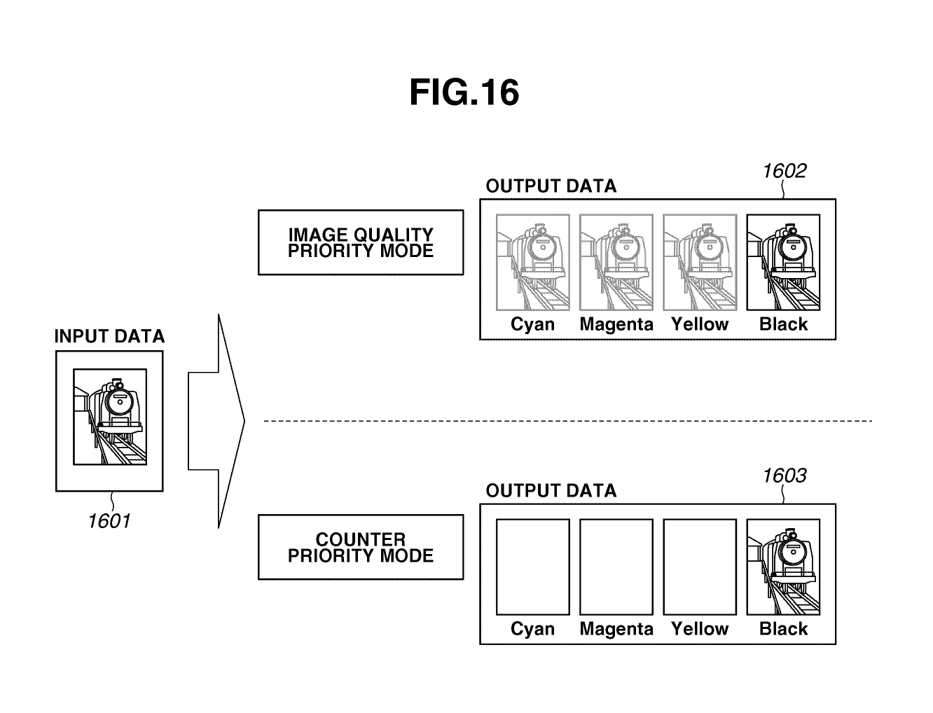

Hereinafter, the image quality priority setting and the counter priority setting to be made as the setting for the color processing system CMS are described below in detail. According to the “image quality priority setting”, data representing an image displayed in achromatic colors such as black and gray is reproduced by mixing ink of four types of colors, i.e., cyan (C), magenta (M), yellow (Y) and black (BK). Thus, the smooth gradation can be achieved and the image quality can be enhanced. For example, when a gray image illustrated in FIG. 16 is input to the apparatus, images 1602 formed using cyan-ink, magenta-ink, yellow-ink and black-ink are output. In other words, C-toner, M-toner, Y-toner, and BK-toner are mixed. Accordingly, the smooth gradation can be achieved. As compared with the mode using only a single color BK, output images are increased in color-density and color-depth. Accordingly, the chromatic-color/achromatic-color counter of the printer counts the output image as a chromatic one. However, running cost is high. According to the “counter priority setting”, achromatic-color data representing a black or gray image is reproduced with ink of a single color, i.e., BK. Thus, a printing-machine is operated in an achromatic-color mode. Accordingly, damage to each of color units respectively corresponding to C, M, and Y of the printing-machine can be reduced. For example, when an input image 1601 illustrated in FIG. 16 is input thereto, an image 1603 is output using only BK. Because the image is reproduced using only BK, the image is reduced in color-density and color-depth and graininess worsens, as compared with the case of mixing M and Y with BK. However, the chromatic-color/achromatic-color counter of the printer counts even a chromatic image as an achromatic one. The running cost can be suppressed. In an electrophotographic process, the chromatic-color/achromatic-color counter counts a case using C-toner, M-toner, and Y-toner as a chromatic one. On the other hand, the chromatic-color/achromatic-color counter counts a case using only BK-toner without using C-toner, M-toner, and Y-toner as an achromatic one. A value counted by the chromatic-color/achromatic-color counter is referred to, if charging is performed by setting a charge for each single chromatic one and for each single achromatic one. Generally, the charge for each single chromatic electrophotography is higher than that for each signal achromatic one. Therefore, achromatic printing is more cost-effective, as compared with chromatic printing.

FIG. 4 is a flowchart illustrating in detail a flow of the process of generating a variable DL, which is performed in step 205 of the flowchart illustrated in FIG. 2. In step 401, the CPU 114 makes the counter priority setting as the setting for the color processing system CMS. In step 402, the CPU 114 converts the color value of the target data into the device color-value according to the counter priority setting.

In step 403, the CPU 114 generates a variable DL from the target data whose color value is converted into a device color-value according to the counter priority setting. In step 404, the CPU 114 determines whether the device color into which the color value of the data is converted includes a chromatic-color. If the CPU 114 determines that the device color includes a chromatic-color (Yes in step 404), the CPU 114 proceeds to step 405. If the CPU 114 determines that the device color doesn't include a chromatic-color (No in step 404), the CPU 114 proceeds to step 406.

In step 405, the CPU 114 increments and sets the value of a chromatic-color/achromatic-color flag of the variable DL to a chromatic-color. In step 406, the CPU 114 doesn't increment the value of the chromatic-color/achromatic-color flag of the variable DL. Thus, the value of a chromatic-color/achromatic-color flag is set to an achromatic-color. In step 407, the generated counter priority DL is saved. Then, the process is ended.

Thus, the two reusable DLs, i.e., the image quality priority DL and the counter priority DL are generated from the reusable data. In the foregoing description, the flowchart for switching, according to whether the device color corresponding to the variable DL generated from the variable data includes a chromatic-color in each page, between the image quality priority DL and the counter priority DL has been described. If the device color corresponding to the variable DL includes a chromatic-color, the image quality priority setting is employed. If the device color corresponding to the variable DL includes no chromatic-color, the counter priority setting is employed.

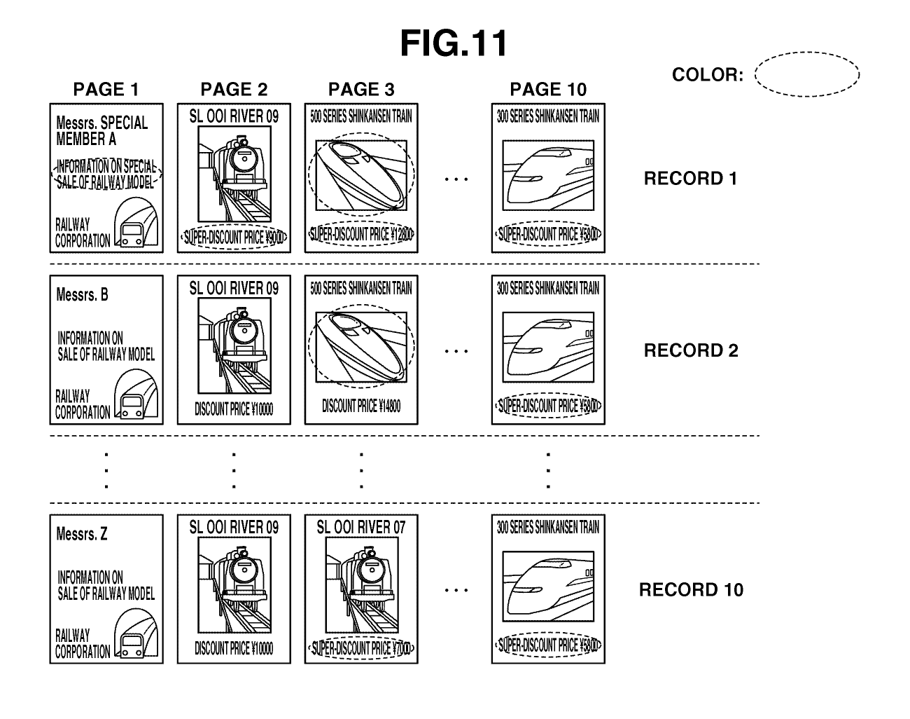

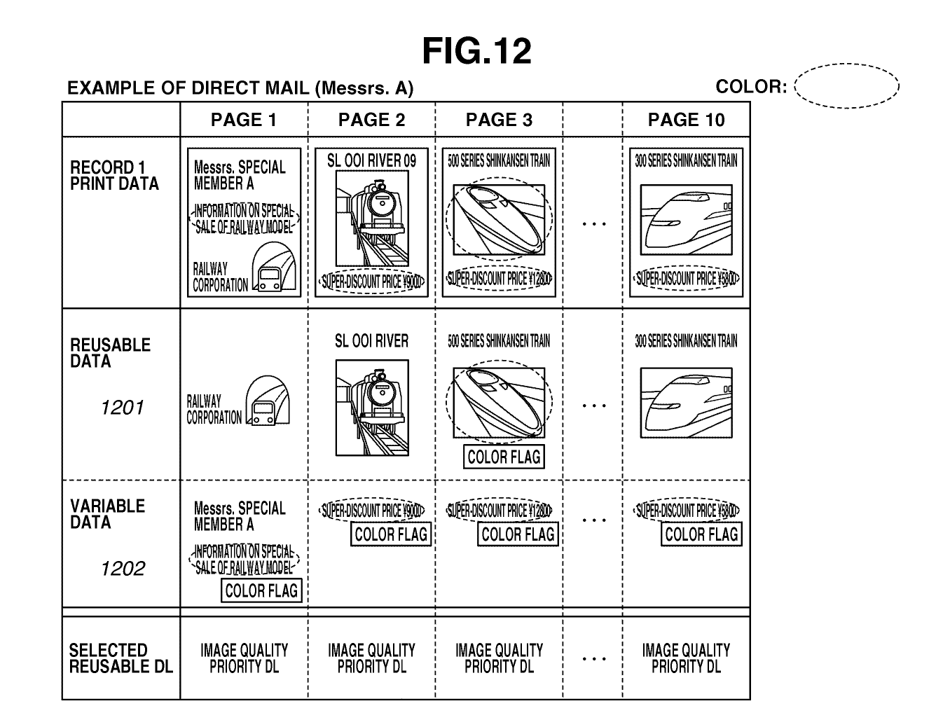

Specific examples are described hereinafter with reference to FIGS. 11, 12, 13, and 14. First, as illustrated in FIG. 11, Record 1 includes printed pages of a direct mail to Messrs. A. Similarly, Record 2 includes printed pages of a direct mail to Messrs. B. Recording 3 includes printed pages of a direct mail to Messrs. Z. In each of the records, a part surrounded by a circle of dashed line indicates data with a color flag, which represents a chromatic-color part. Such data are described hereinafter. First, processing performed on Record 1 for Messrs. A is described hereinafter with reference to FIG. 12. Record 1 includes reusable data 1201 and variable data 1202. The reusable data 1201 for the first time e appears here, from which image quality priority DL and counter priority DL are generated. Next, in each of Pages 1, 2, 3, and 10, the color value of the variable data includes a chromatic-color. Thus, in each page, the image quality priority DL is selected as the reusable DL. Then, a bitmap image is generated therefrom.

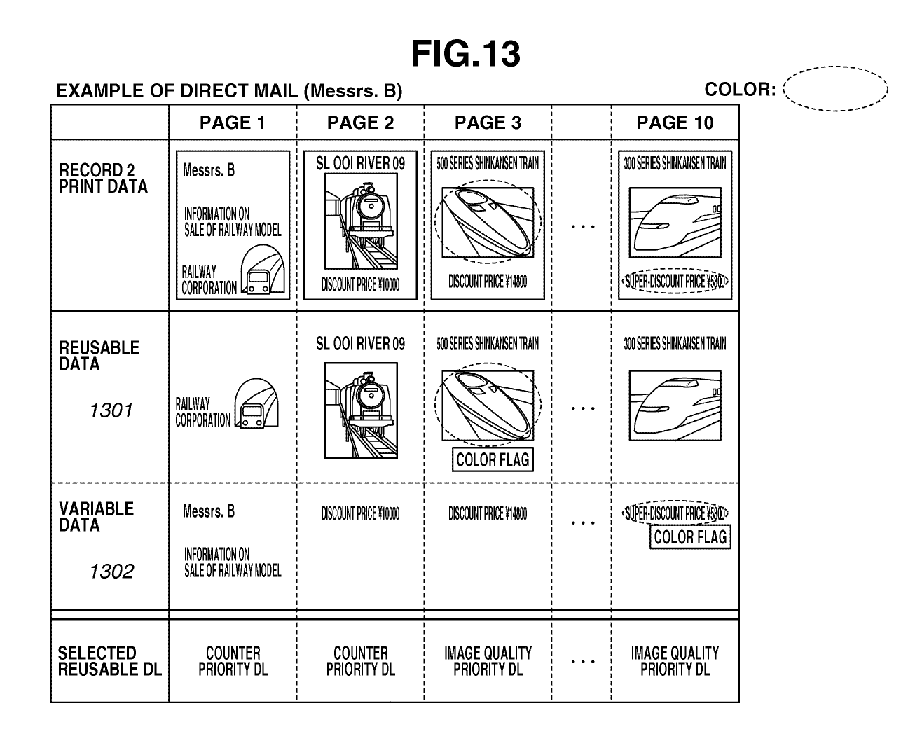

Next, processing on Record 2 for Messrs. B is described with reference to FIG. 13. Record 2 includes reusable data 1301 and variable data 1302. Reusable data has already appeared in Record 1. Thus, both of the reusable image quality priority DL and the reusable counter priority DL have already been generated. Accordingly, it is unnecessary to regenerate the reusable image quality priority DL and the reusable counter priority DL. Thus, an example of speeding up VDP, as compared with the conventional VDP, has been described. Next, the color value of the variable data includes no chromatic-color. Similarly, the color value of the reusable data has no chromatic-color. Thus, the reusable DL to be selected is a counter priority DL. In Page 3, the color value of the reusable data has a chromatic-color. Thus, the reusable DL to be selected is an image quality priority DL. In Page 4, the color value of the variable data has a chromatic-color. Thus, a reusable DL to be selected is an image quality priority DL.

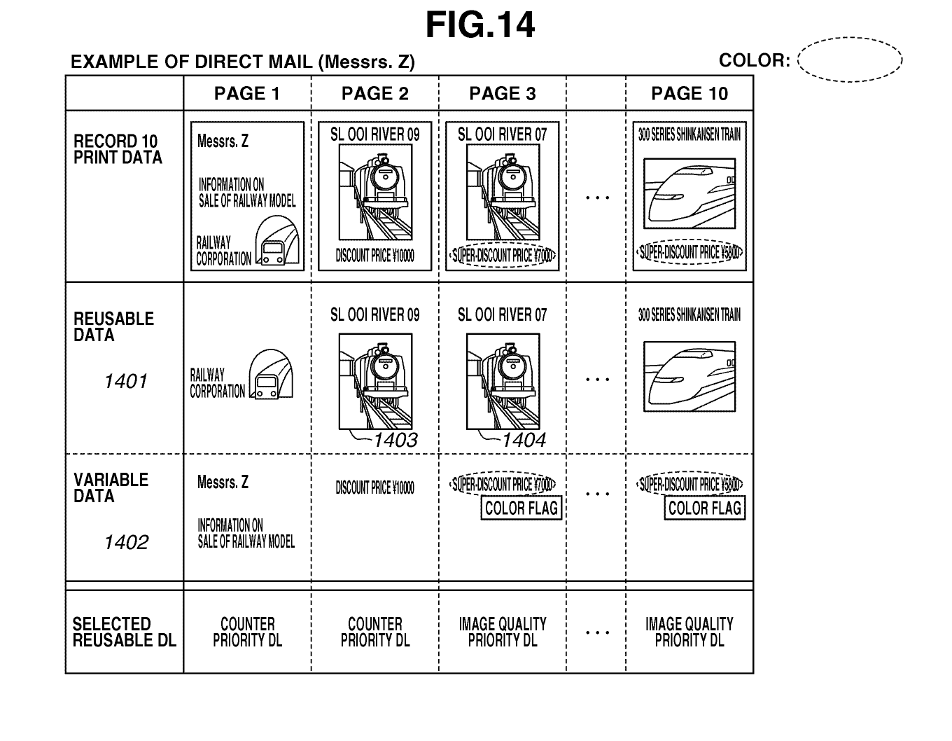

Next, processing on Record 10 for Messrs. Z is described with reference to FIG. 14. Record 10 includes reusable data 1401 and variable data 1402. In Record 1, the reusable data has already been generated. Thus, the image quality priority DL and the counter priority DL have already been generated. Next, in Pages 1 and 2, the color-value of the variable data includes no chromatic-color. In addition, the color-value of the reusable data includes no chromatic-color. Thus, the reusable DL to be selected is a counter priority DL. In Page 3, the color-value of the variable data includes a chromatic-color. Thus, the reusable DL to be selected is an image quality priority DL. In Page 4, the color-value of the variable data includes a chromatic-color. Consequently, the reusable DL to be selected is an image quality priority DL.

Thus, each apparently achromatic page is output in achromatic format. Consequently, the cost can be suppressed. An achromatic part of a page whose color value includes a chromatic-color is printed using colors C, M, Y, and BK, as designated by reference numeral 1602 in FIG. 16. Printing can be performed such that the gradation of a photograph part smoothly changes, and color-density and color-depth of black are increased.

The gradation of a black or gray part can be smoothly changed by employing, if the color-value of the reusable data in each page includes a chromatic-color, the image quality priority setting. The black or gray part is printed with toner of a single color, i.e., BK, and the cost can be reduced by employing, if the color-value of the reusable data in each page includes no chromatic-color, the counter priority setting. In other words, both of image-quality and cost-effectiveness can be enhanced without largely reducing VDP performance.

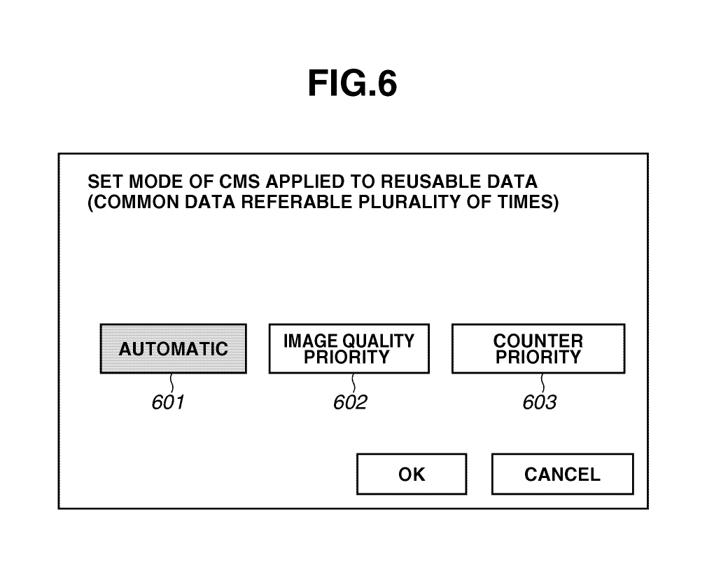

Hereinafter, a second exemplary embodiment is described. In the first exemplary embodiment, whether the setting is the image quality priority setting or the counter priority setting is substantially automatically selected. However, some users strongly wish to employ the image quality priority setting to implement smooth tonal change. Some users wish to output an image of a black object in an achromatic-color by employing the counter priority setting. Thus, a user's desired output of image data is enabled by displaying on the UI 13 a screen, as illustrated in FIG. 6, in which a mode of determining the setting for the CMS applied to reusable data is selected among an automatic selection mode 601 similar to the automatic selection according to the first exemplary embodiment, a mode 602 of manually selecting the image quality priority setting, and a mode 603 of manually selecting the counter priority setting. If the automatic selection mode 601 is selected, a DL and a bitmap image are generated by performing the method according to the first exemplary embodiment. If the mode 602 of manually selecting the image quality priority setting is selected, only an image quality priority DL is generated for each of all of the reusable data. In addition, a bitmap image is generated using the generated image quality priority DL. If the mode 603 of manually selecting the counter priority setting is selected, only a counter priority DL is generated for each of all of the reusable data. In addition, a bitmap image is generated using the generated counter priority DL.

Hereinafter, a third exemplary embodiment is described. In the first exemplary embodiment, and the second exemplary embodiment, the setting for the CMS applied to the reusable data is made regardless of the types of objects such as a text, a graphic, and an image. Some users wish to perform a desired output of data. Thus, the wishes of such users can be implemented by displaying on the UI 13 a screen from which the setting for the CMS can be selected corresponding to each of attributes such as a text, a graphic, and an image. According to the screen illustrated in FIG. 3, a user selects, from the settings corresponding to buttons 701 though 703, the setting for the CMS corresponding to the case where the object type is a text. A user selects, from the settings corresponding to buttons 704 though 706, the setting for the CMS corresponding to the case where the object type is a graphic. A user selects, from the settings corresponding to buttons 707 though 709, the setting for the CMS corresponding to the case where the object type is a graphic. Consequently, the user's desired setting for the CMS corresponding to each object type can be made.

Hereinafter, a fourth exemplary embodiment is described. In a method according to a first exemplary embodiment, the counter priority setting and the image quality priority setting may be switched every page with respect to the same reusable data image for the same user (or record). Accordingly, the image-quality of the same image printed on a plurality of pages included in the same record can vary with the plurality of pages. More specifically, an image 1403 illustrated in FIG. 14 is printed in a single color BK according to the counter priority setting, similarly to an image 1603 illustrated in FIG. 16. An image 1404 illustrated in FIG. 14 is printed in four colors C, M, Y, and BK according to the image quality priority setting, similarly to an image illustrated in FIG. 16.

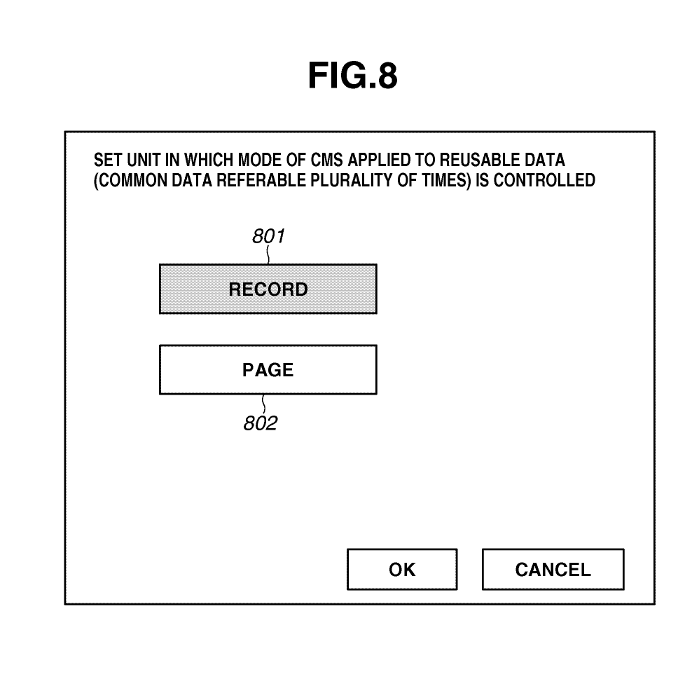

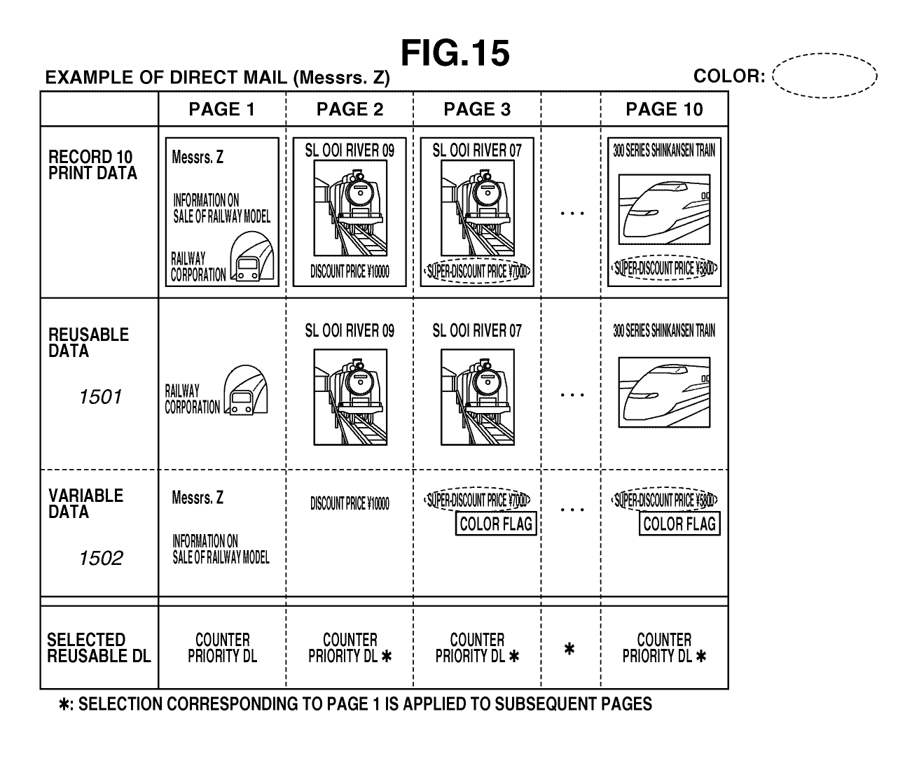

Thus, as illustrated in FIG. 8, the setting for the CMS applied to the reusable data can be controlled record by record or page by page. The example illustrated in FIG. 14 according to the first exemplary embodiment corresponds to the button 802 illustrated in FIG. 8for page-unit control of the setting for the CMS. The example illustrated in FIG. 15 corresponds to the button 801 illustrated in FIG. 8 for record-unit control. Normally, the image quality priority setting is applied to data of Page 3. However, the counter priority setting to data of Page 1 is applied to the subsequent pages. Consequently, the counter priority setting applied to output data 1603 illustrated in FIG. 16 is also applied to reusable data of both Page 2 and Page 3. Accordingly, the difference in the setting among the pages can be eliminated.

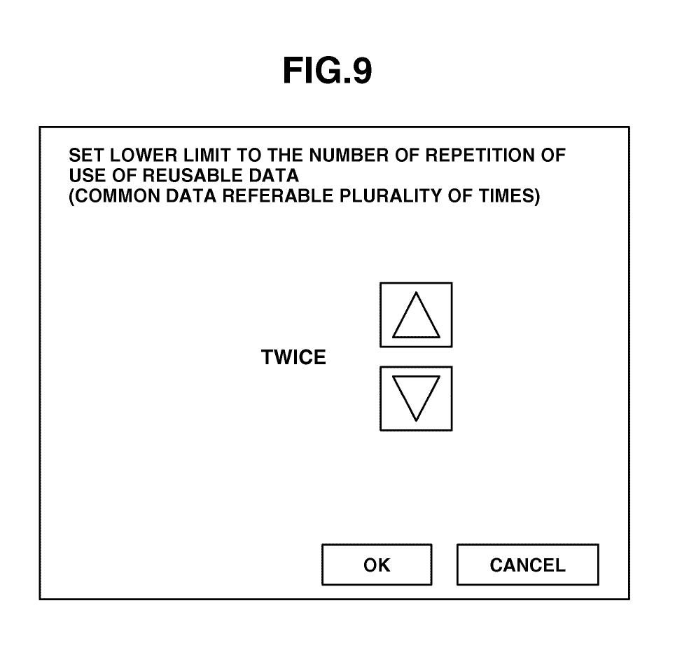

Hereinafter, a fifth exemplary embodiment is described. According to first through fourth exemplary embodiments, the image quality priority DL and the counter priority DL are generated regardless of the number of times of repeatedly using the reusable data. However, if the number of times of repeatedly using the reusable data is small, the performance may extremely be lowered by generating two DLs, as compared with conventional apparatuses. To avoid delay of processing, the number of times of repeatedly using the data is regulated depending on users so that the generation of an image quality priority DL and a counter priority DL can be inhibited when the number of times of repeatedly using the data is small. Consequently, the performance of the apparatus can be changed to be equal to a user's desired performance. FIG. 9 illustrates an example of a screen for setting the lower limit of the number of times of repeatedly using the data, which is displayed on the UI 13. If the number of times of repeatedly using the data is larger than the value specified on the screen by a user, two types of reusable DLs are generated, similarly to the first exemplary embodiment. If the number of times of repeatedly using the data is smaller than the value specified on the screen by a user, only one type of DLs are generated.

Hereinafter, a sixth exemplary embodiment is described. According to the first exemplary embodiment, two DLs, i.e., an image quality priority DL and a counter priority DL are generated as reusable DLs. In addition, according to variable data, a DL to be used is switched between the image quality priority DL and the counter priority DL. On the other hand, according to the sixth exemplary embodiment, a button 1001 is selected depending on objects which are particular about colors such as a corporate color, and a custom ink-color. Thus, the switching between the image quality priority DL and the counter priority DL can be inhibited for such objects.

More specifically, the image quality priority setting is forcibly selected for the reusable data representing objects whose colors are specified in a separation color space with data that describes custom ink-colors. Thus, prioritization of colors is enabled. Accordingly, users ‘desired setting is enabled.

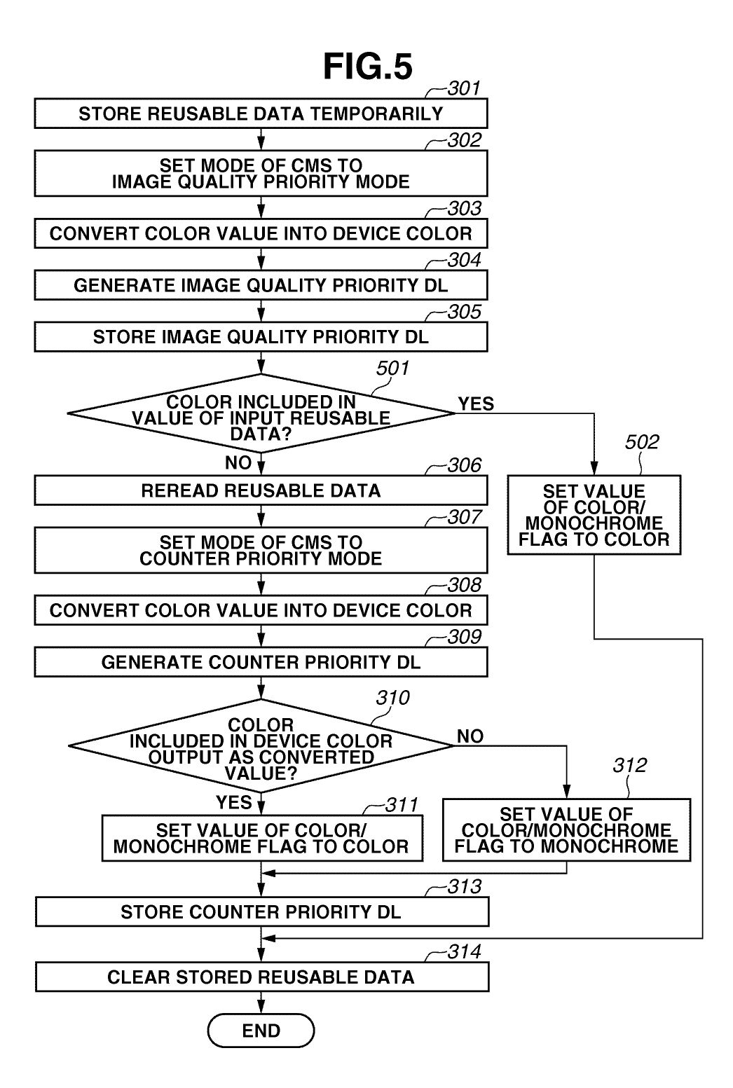

Hereinafter, a seventh exemplary embodiment is described, which omits, when two reusable DLs, i.e., an image quality priority DL and a counter priority DL are generated, the generation of the counter priority DL depending on the reusable data. FIG. 5 is a flowchart illustrating a flow of a reusable-DL generation process according to the present exemplary embodiment. However, processing similar to that described with reference to FIG. 3 is designated with the same reference numeral. Thus, description of such processing is omitted.

In step 501, the CPU 114 determines whether input values of reusable data include a chromatic-color. In the present exemplary embodiment, in cases where the input values are only R=G=B, or C=M=Y=0, or the input values represent only grays, the CPU 114 determines that the input values includes no values representing chromatic-colors. If the CPU 114 determines that the input values include a value representing a chromatic-color, the CPU 114 proceeds to step 502. If the CPU 114 determines that the input values include no value representing a chromatic-color, the CPU 114 proceeds to step 306. In step 502, the CPU 114 increments and sets the value of the color flag to a value representing a chromatic-color. Then, the CPU 114 proceeds to step 517. At that time, a counter priority DL is not generated.

Thus, the generation of a counter priority DL is omitted depending on the input value of reusable data. Consequently, performance can be enhanced.

The present invention can provide an image processing apparatus capable of switching, according to the property of reusable data included in each page, the setting for the color processing, and performing image processing with good balance between the image quality and the cost

The exemplary embodiments according to the present invention is not limited to the configuration of the apparatus described herein. The present invention can be applied to any configuration, as long as apparatuses of such configurations can achieve functions described in the appended claims and the above embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-204250 filed Sep. 13, 2010, which is hereby incorporated by reference herein in its entirety.

What is claimed is:

1. An image processing apparatus for processing VDP data including reusable data which is repeatedly utilized in a plurality of pages, and variable data which is not repeatedly utilized, comprising:
a generation unit configured to generate a plurality of intermediate language data from the reusable data according to a plurality of settings for color processing;
a selection unit configured to select intermediate language data to be used when generating a bitmap image from the plurality of intermediate language data generated by the generation unit; and
a RIP unit configured to generate a bitmap image by performing RIP-processing on the intermediate language data selected by the selection unit.

2. The image processing apparatus according to claim 1, wherein the generation unit generates from the variable data single intermediate language data according to a setting for color processing.

3. The image processing apparatus according to claim 1, wherein the generation unit generates image quality priority intermediate language data based on an image quality priority setting for reproducing achromatic-color data using a plurality of colors, and counter priority intermediate language data for reproducing the achromatic-color data using a monochromatic color.

4. The image processing apparatus according to claim 3, wherein the selection unit selects, if a page including the reusable data includes a chromatic-color, the image quality priority intermediate language data, and wherein the selection unit selects, if a page including the reusable data includes no chromatic-color, the counter priority intermediate language data.

5. The image processing apparatus according to claim 3, wherein, if the reusable data is not achromatic-color data, the generation unit generates only the image quality priority intermediate language data and does not generate the counter priority intermediate language data.

6. The image processing apparatus according to claim 1, further comprising:
a display unit configured to generate the image quality priority intermediate language data and the counter priority intermediate language data, and to display a screen for selecting one of a method for selecting, from a plurality of generated intermediate language data intermediate language data to be used for RIP-processing, a method for generating the image quality priority intermediate language data and using the generated image quality priority intermediate language data in RIP-processing, and a method for generating the counter priority intermediate language data and using the generated counter priority intermediate language data in RIP-processing.

7. The image processing apparatus according to claim 6, wherein the display unit generates, depending on each object type, the image quality priority intermediate language data and the counter priority intermediate language data, and displays a screen for selecting one of a method for selecting from a plurality of generated intermediate language data intermediate language data to be used for RIP-processing, a method for generating the image quality priority intermediate language data and using the generated image quality priority intermediate language data in RIP-processing, and a method for generating the counter priority intermediate language data and using the generated counter priority intermediate language data in RIP-processing.

8. A method for controlling an image processing apparatus configured to process VDP data including reusable data which is repeatedly utilized in a plurality of pages, and variable data which is not repeatedly utilized in a plurality of pages, comprising:
generating, from the reusable data, a plurality of intermediate language data according to a plurality of color processing settings;
selecting from the generated plurality of intermediate language data, intermediate language data to be used when generating a bitmap image; and
generating a bitmap image by performing RIP-processing on the selected intermediate language data.

9. A storage medium storing a program for executing a method for causing an image processing apparatus to process VDP data including reusable data which is repeatedly utilized in a plurality of pages, and variable data which is not repeatedly utilized in a plurality of pages, the method comprising:
generating, from the reusable data, a plurality of intermediate language data according to a plurality of color processing settings;
selecting from the generated plurality of intermediate language data, intermediate language data to be used when generating a bitmap image; and
generating a bitmap image by performing RIP-processing on the selected intermediate language data.
